(19) United States
(12) Patent Application Publication
(10) Pub. No.: US 2025/0300254 A1
(43) Pub. Date: Sep. 25, 2025

(54) STACKED STRUCTURE

(71) Applicant: TOYOTA JIDOSHA KABUSHIKI KAISHA, Toyota-shi (JP)

(72) Inventor: Yoshiro KAMO, Ashigarakami-gun (JP)

(73) Assignee: TOYOTA JIDOSHA KABUSHIKI KAISHA, Toyota-shi (JP)

(21) Appl. No.: 18/973,293

(22) Filed: Dec. 9, 2024

(30) Foreign Application Priority Data
Mar. 21, 2024 (JP) 2024-045033

(51) Int. Cl. H01M 10/48; B60R 16/033; H01M 50/258; H01M 50/502

(52) U.S. Cl. CPC H01M 10/486; H01M 50/258; H01M 50/502; B60R 16/033; H01M 2220/20

(57) ABSTRACT

The stacked structure includes a battery module, a conductive member, a first conductive adhesive, and a first temperature sensor. The conductive member is laminated on the battery module. The first conductive adhesive is disposed between the battery module and the conductive member. The first conductive adhesive adheres the battery module and the conductive member to each other. The first conductive adhesive electrically connects the battery module and the conductive member to each other. The first temperature sensor is disposed between the battery module and the conductive member to be in contact with the first conductive adhesive.

### CROSS-REFERENCE TO RELATED APPLICATION

This application claims priority to Japanese Patent Application No. 2024-045033 filed on Mar. 21, 2024, incorporated herein by reference in its entirety.

### BACKGROUND

### 1. Technical Field

The present disclosure relates to a stacked structure.

### 2. Description of Related Art

Japanese Unexamined Patent Application Publication No. 2022-175828 (JP 2022-175828 A) discloses a related-art stacked structure, and specifically discloses a module stack.

The module stack includes a plurality of power storage modules stacked in a first direction and a plurality of current collector plates. The power storage modules are stacked in the first direction via the current collector plate. The module stack includes a plurality of detection elements disposed on both sides in a second direction across the current collector plate interposed between the power storage modules. The second direction is orthogonal to the first direction. The detection elements are, for example, sensors that monitor a state of the power storage module and include a temperature detection element that detects a temperature of the power storage module and a voltage detection element that detects a voltage output from the power storage module.

### SUMMARY

A conductive adhesive may be provided between a battery module (power storage module) and a conductive member such as the current collector plate stacked on the battery module. In such a stacked structure, the conductive adhesive may be partially peeled off from the battery module or the conductive member. In particular, when the size of the stacked structure is increased in a direction intersecting the stack direction, the above partial peeling is likely to occur.

In the module stack disclosed in JP 2022-175828 A, if the conductive adhesive is provided between the power storage module and the current collector plate, the above detection element may be unable to detect the partial peeling of the conductive adhesive.

The present disclosure has been made in view of the above problems, and an object of the present disclosure is to provide a stacked structure in which partial peeling of a conductive adhesive can be detected accurately.

A stacked structure according to one aspect of the present disclosure includes:
a battery module;
a conductive member;
a first conductive adhesive; and
a first temperature sensor.

The conductive member is stacked on the battery module.

The first conductive adhesive is disposed between the battery module and the conductive member. The first conductive adhesive bonds the battery module and the conductive member to each other. The first conductive adhesive electrically connects the battery module and the conductive member to each other.

The first temperature sensor is disposed between the battery module and the conductive member to be in contact with the first conductive adhesive.

In the above configuration, the first conductive adhesive generates heat when electricity flows in the stack direction of the stacked structure. When the first conductive adhesive is partially peeled off from the battery module or the conductive member, the interface resistance between the first conductive adhesive and the battery module or the conductive member increases. Thus, the first conductive adhesive further generates heat, and the temperature of the first conductive adhesive increases. By detecting this temperature increase by the first temperature sensor in contact with the first conductive adhesive, it is possible to accurately detect that the partial peeling occurs.

The stacked structure according to the one aspect of the present disclosure preferably further includes one or more second conductive adhesives.

Each of the one or more second conductive adhesives is disposed between the battery module and the conductive member. Each of the one or more second conductive adhesives bonds the battery module and the conductive member to each other. Each of the one or more second conductive adhesives electrically connects the battery module and the conductive member to each other.

The first conductive adhesive and the one or more second conductive adhesives are arranged away from each other in a second direction intersecting a first direction.

The first direction is a direction in which the battery module and the conductive member are stacked. The first conductive adhesive is farthest from a center of the conductive member in the second direction among the first conductive adhesive and the one or more second conductive adhesives.

In the above configuration, the first conductive adhesive is positioned in this manner, and therefore the partial peeling is relatively likely to occur among the first conductive adhesive and the one or more second conductive adhesives, for example, when the stacked structure is distorted. By detecting the temperature increase by the first temperature sensor in contact with the first conductive adhesive, it is possible to accurately detect that an abnormality occurs in the adhesive between the battery module and the conductive member.

The stacked structure according to the one aspect of the present disclosure preferably further includes one or more second temperature sensors.

Each of the one or more second temperature sensors is disposed between the battery module and the conductive member to be in contact with the first conductive adhesive.

The first temperature sensor and the one or more second temperature sensors are arranged away from each other in a third direction intersecting a first direction.

The first direction is a direction in which the battery module and the conductive member are stacked. The first temperature sensor is farthest from a center of the conductive member in the third direction among the first temperature sensor and the one or more second temperature sensors.

In the above configuration, the first temperature sensor is disposed, among the first temperature sensor and the one or more second temperature sensors, at a portion where the partial peeling of the first conductive adhesive is relatively likely to occur, for example, when the stacked structure is distorted. By detecting the temperature increase by the first temperature sensor, it is possible to more accurately detect the partial peeling of the first conductive adhesive.

The stacked structure according to the one aspect of the present disclosure preferably further includes one or more second temperature sensors.

Each of the one or more second temperature sensors is disposed between the battery module and the conductive member to be in contact with the first conductive adhesive.

The first temperature sensor and the one or more second temperature sensors are arranged away from each other in a third direction intersecting both the first direction and the second direction.

The first temperature sensor is farthest from a center of the conductive member in the third direction among the first temperature sensor and the one or more second temperature sensors.

The first conductive adhesive is preferably farthest from the center of the conductive member in the second direction among the first conductive adhesive and the one or more second conductive adhesives. In addition, in the above configuration, the first temperature sensor is disposed at a portion of the first conductive adhesive where the partial peeling is most likely to occur in the third direction intersecting the second direction. By detecting the temperature increase by the first temperature sensor, it is possible to more accurately detect that an abnormality occurs in the adhesive between the battery module and the conductive member.

In the stacked structure according to the one aspect of the present disclosure, the first direction, the second direction, and the third direction are preferably orthogonal to each other.

The first conductive adhesive and the one or more second conductive adhesives extend parallel to the third direction.

In the above configuration, the first conductive adhesive and the one or more second conductive adhesives are disposed in a well-balanced manner between the battery module and the conductive member. Therefore, the battery module and the conductive member are more firmly connected to each other while suppressing the use amount of the conductive adhesive.

According to the present disclosure, it is possible to accurately detect the partial peeling of the conductive adhesive.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle described in an embodiment of the present disclosure;

FIG. 2 is a cross-sectional view schematically illustrating a power storage device including a stacked structure and a vehicle share panel according to an embodiment of the present disclosure;

FIG. 3 is a cross-sectional view partially illustrating a power storage device including a stacked structure according to an embodiment of the present disclosure;

FIG. 4 is a schematic plan view of a current-carrying plate as a conductive member viewed from a first direction together with another partial configuration;

FIG. 5 is a schematic plan view of a cooler as a conductive member viewed from a first direction together with another partial configuration; and

FIG. 6 is a partial cross-sectional view schematically showing a state in which the power storage device is deformed when the power storage device is pushed up from the lower side.

### DETAILED DESCRIPTION OF EMBODIMENTS

Hereinafter, a stacked structure according to an embodiment of the present disclosure will be described with reference to the drawings. In the following description of the embodiments, the same or corresponding parts in the drawings are denoted by the same reference numerals, and the description thereof will not be repeated.

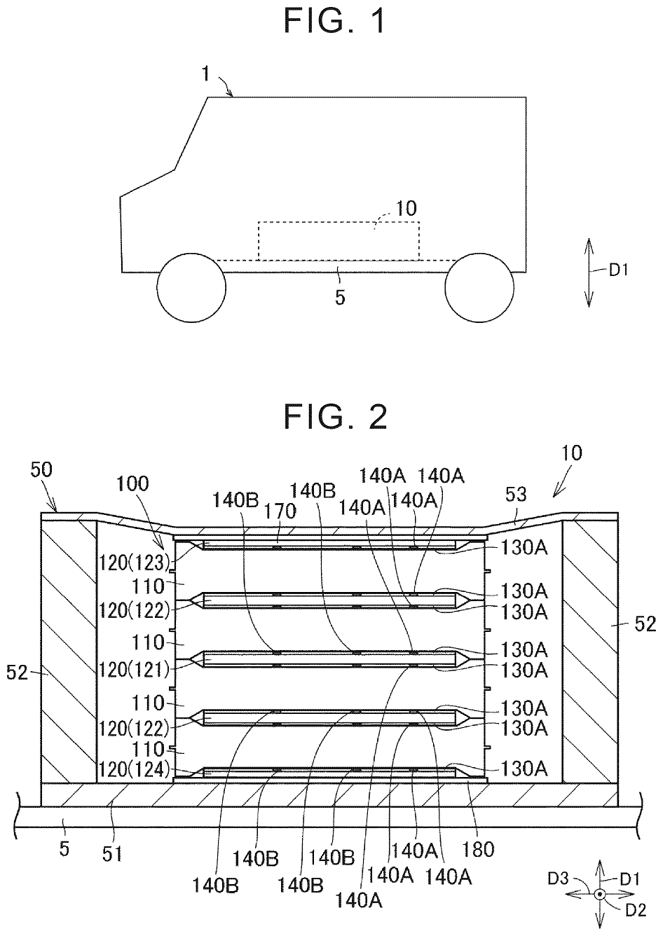

FIG. 1 is a diagram schematically illustrating a vehicle described in an embodiment of the present disclosure. FIG. 2 is a cross-sectional view schematically illustrating a power storage device including a stacked structure and a vehicle share panel according to an embodiment of the present disclosure.

As illustrated in FIGS. 1 and 2, the stacked structure 100 according to the present disclosure may be included in the power storage device 10 that can be mounted on the vehicle 1. The first direction D1 in the present embodiment may be a vertical direction. In FIG. 2, a cross section taken from a second direction D2 perpendicular to the first direction D1 is illustrated. The second direction D2 is a direction intersecting the first direction D1, specifically, a direction perpendicular to the first direction D1.

The vehicle 1 includes a share panel 5 and a power storage device 10. The share panel 5 is provided at the bottom of the vehicle 1. The share panel 5 covers the power storage device 10 mounted on the vehicle 1 from the lower side. The share panel 5 is made of a metal material.

The power storage device 10 includes a case 50 and a stacked structure 100. The case 50 houses the stacked structure 100. The case 50 includes a bottom surface portion 51, a peripheral wall portion 52, and a top surface portion 53.

The bottom surface portion 51 is disposed on the share panel 5. The stacked structure 100 is disposed on the bottom surface portion 51. The peripheral wall portion 52 stands upward from the bottom surface portion 51. The peripheral wall portion 52 surrounds the entire circumference of the stacked structure 100. The top surface portion 53 covers the peripheral wall portion 52 and the stacked structure 100 from above. The top surface portion 53 is in contact with the stacked structure 100.

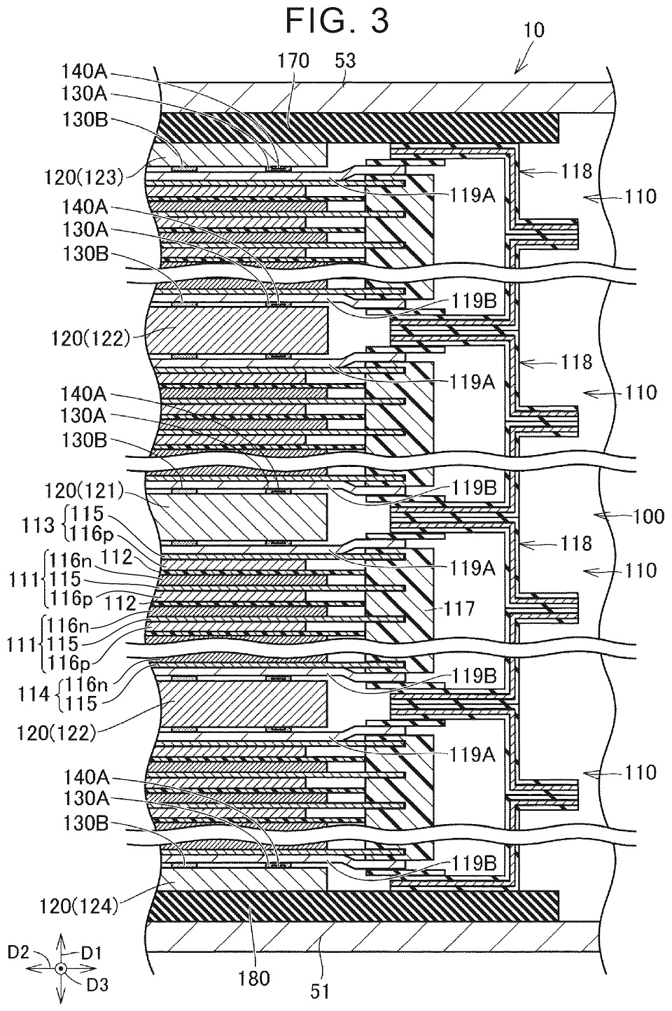

FIG. 3 is a cross-sectional view partially illustrating a power storage device including a stacked structure according to an embodiment of the present disclosure. In FIG. 3, a cross-section taken from a third direction D3 intersecting both the first direction D1 and the second direction D2 is illustrated. The third direction D3 is in particular a direction perpendicular to both the first direction D1 and the second direction D2.

As shown in FIGS. 2 and 3, the stacked structure 100 includes a battery module 110, a conductive member 120, a first conductive adhesive 130A, a second conductive adhesive 130B, a first temperature sensor 140A, a second temperature sensor 140B, and a third temperature sensor 140C.

The stacked structure 100 includes a plurality of battery modules 110. The plurality of battery modules 110 are arranged in the first direction D1. Each of the plurality of battery modules 110 is a secondary battery such as a lithium-ion battery.

Each of the plurality of battery modules 110 includes a plurality of electrode plates 111, a plurality of separators 112, a positive terminal electrode 113, and a negative terminal electrode 114. The plurality of electrode plates 111, the positive terminal electrode 113, and the negative terminal electrode 114 are stacked on the first direction D1 via the separators 112.

The plurality of electrode plates 111 are provided between the positive terminal electrode 113 and the negative terminal electrode 114. The electrode plate 111 is, for example, a bipolar electrode. The electrode plate 111 includes a current collector 115, a positive electrode layer 116p, and a negative electrode layer 116n.

The positive terminal electrode 113 is located on one side in the stacking direction with respect to the plurality of electrode plates 111. The positive terminal electrode 113 includes a current collector 115 and a positive electrode layer 116p. The negative terminal electrode 114 is located on the other side in the stacking direction with respect to the plurality of electrode plates 111. The negative terminal electrode 114 includes a current collector 115 and a negative electrode layer 116n.

Each of the plurality of battery modules further includes a resin sealing body 117 and an exterior body 118. The resin sealing body 117 is provided so as to seal the entire periphery of the plurality of electrode plates 111, the plurality of separators 112, the positive terminal electrode 113, and the negative terminal electrode 114.

The exterior body 118 seals the plurality of electrode plates 111, the plurality of separators 112, the positive terminal electrode 113, the negative terminal electrode 114, and the resin sealing body 117 inside.

The exterior body 118 includes a first conductive plate 119A and a second conductive plate 119B. The first conductive plate 119A is in contact with the current collector 115 of the negative terminal electrode 114. The second conductive plate 119B is in contact with the current collector 115 of the negative terminal electrode 114.

Therefore, in each of the plurality of battery modules 110, the first conductive plate 119A functions as a positive electrode terminal. The second conductive plate 119B functions as a negative electrode terminal. The outer surface of the first conductive plate 119A faces one side in the first direction D1 of the battery module 110, and the outer surface of the second conductive plate 119B faces the other side in the first direction D1 of the plurality of battery modules 110.

The conductive member 120 is stacked on the battery module 110. The direction in which the battery module 110 and the conductive member 120 are stacked is the first direction D1.

Specifically, the stacked structure 100 includes a plurality of conductive members 120. The plurality of conductive members 120 includes a current-carrying plate 121, a plurality of cooling plates 122, a first current collector plate 123, and a second current collector plate 124.

The current-carrying plate 121 and the plurality of cooling plates 122 are arranged one by one between the adjacent battery modules 110 in the plurality of battery modules 110 arranged in the first direction D1. The current-carrying plate 121 is made of, for example, a metal material capable of being energized. The plurality of cooling plates 122 are made of a metal material capable of conducting at least a surface.

The first current collector plate 123 is further disposed on one side of the plurality of battery modules 110 in the first direction D1. The second current collector plate 124 is disposed further on the other side of the plurality of battery modules 110 in the first direction D1. The first current collector plate 123 and the second current collector plate 124 are made of a conductive metal material. In the present embodiment, the first current collector plate 123 is disposed above the plurality of battery modules 110. The second current collector plate 124 is disposed below the plurality of battery modules 110.

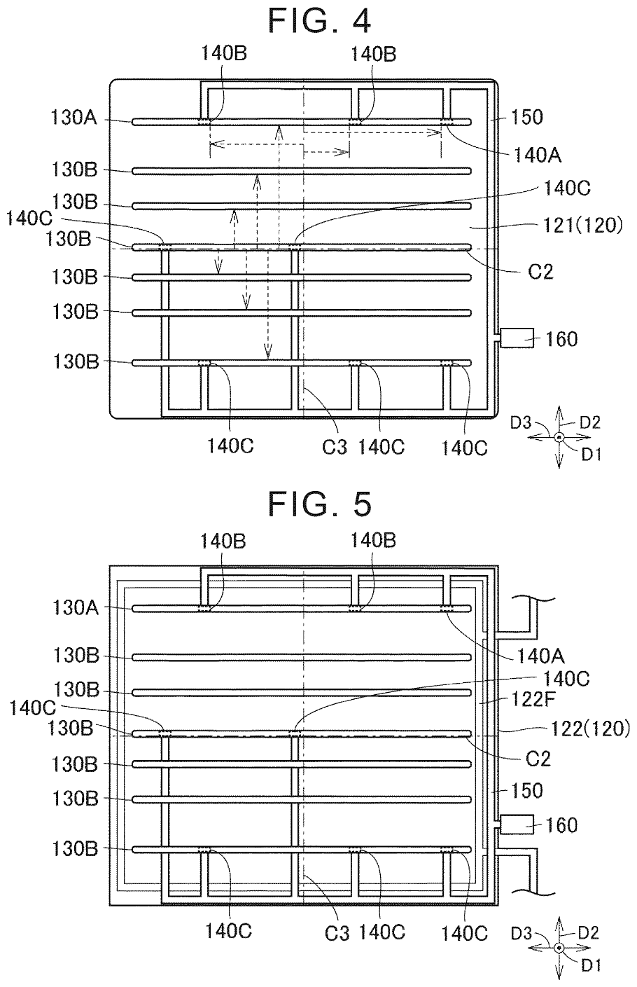

FIG. 4 is a schematic plan view of a current-carrying plate as a conductive member viewed from a first direction together with another partial configuration. FIG. 5 is a schematic plan view of a cooler as a conductive member as viewed from a first direction together with another partial configuration.

As shown in FIGS. 2 to 5, each of the first conductive adhesive 130A, the one or more second conductive adhesive 130B, the first conductive adhesive 130A, the first temperature sensor 140A, the one or more second temperature sensor 140B, and the one or more third temperature sensor 140C is disposed between the battery module 110 and the conductive member 120.

In the present embodiment, the configuration of each adhesive material and each temperature sensor between the battery module 110 and the current-carrying plate 121 adjacent to each other in the first direction D1, the configuration of each adhesive material and each temperature sensor between the battery module 110 and the cooling plate 122, the configuration of each adhesive material and each temperature sensor between the battery module 110 and the first current collector plate 123, and the configuration of each adhesive material and each temperature sensor between the battery module 110 and the second current collector plate 124 may be the same as or different from each other. Further, when viewed from one current-carrying plate 121 or one cooling plate 122, the configuration of the adhesive and each temperature sensor provided between the adjacent battery modules 110 on one side and the configuration of the adhesive and each temperature sensor provided between the adjacent battery modules 110 on the other side may be the same or different from each other.

In the following explanation, the configuration of each adhesive material and each sensor will be described with attention paid between one of the plurality of battery modules 110 and the conductive member 120 laminated on one side or the other side of the battery module 110 in the first direction D1. That is, the conductive member 120 described below may be any one of the current-carrying plate 121, the cooling plate 122, the first current collector plate 123, and the second current collector plate 124, unless otherwise specified.

As shown in FIG. 3 and the like, each of the first conductive adhesive 130A and the one or more second conductive adhesive 130B adheres the battery module 110 and the conductive member 120 to each other. Specifically, the first conductive plate 119A or the second conductive plate 119B and the conductive member 120 are bonded to each other.

Each of the first conductive adhesive 130A and the one or more second conductive adhesive 130B electrically connects the battery module 110 and the conductive member 120 to each other. Specifically, the first conductive plate 119A or the second conductive plate 119B and the conductive member 120 are electrically connected to each other.

The first conductive adhesive 130A and the one or more second conductive adhesive 130B are spaced apart in a second direction D2. The first conductive adhesive 130A is farthest from the center C2 of the conductive member 120 in the second direction D2 among the first conductive adhesive 130A and the one or more second conductive adhesive 130B.

Each of the first conductive adhesive 130A and the one or more second conductive adhesive 130B extends parallel to the third direction D3.

In the present embodiment, a plurality of second conductive adhesive 130B are disposed between the battery module 110 and the conductive member 120.

A flow path 122F is formed inside the cooling plate 122 (see FIG. 5). The flow path 122F is configured to be able to circulate a coolant. The cooling fluid is, for example, air or water. The flow path 122F extends in a substantially rectangular ring shape when viewed from the first direction D1. Between the battery module 110 and the cooling plate 122, the first conductive adhesive 130A and the one or more second conductive adhesive 130B are located on the inner periphery of the flow path 122F formed in a substantially rectangular ring shape when viewed from the first direction D1.

The first conductive adhesive 130A and the second conductive adhesive 130B are mixed with a metal-based filler. Therefore, the first conductive adhesive material 130A and the second conductive adhesive material 130B have higher electrical resistivity than that of the metallic material, for example, higher electrical resistivity than that of the conductive part of the conductive member 120.

As shown in FIGS. 2 to 5, between the battery module 110 and the conductive member 120, the first temperature sensor 140A and each of the one or more second temperature sensor 140B are disposed to be contacted with the first conductive adhesive 130A. Specifically, each of the first temperature sensor 140A and the one or more second temperature sensor 140B is disposed between the first conductive adhesive 130A and the conductive member 120.

Also, each of the one or more third thermal sensor 140C is positioned to touch any one of the one or more second conductive adhesive 130B. Specifically, each of the one or more third thermal sensor 140C is disposed between any one of the one or more second conductive adhesive 130B and the conductive member 120.

In the present embodiment, a plurality of first temperature sensors 140A and a plurality of second temperature sensors 140B are disposed between the battery module 110 and the conductive member 120. All of the plurality of second temperature sensor 140B are contacted with the first conductive adhesive 130A. However, not all of the second temperature sensor 140B may be contacted with the first conductive adhesive 130A. Only a second temperature sensor 140B of a portion of the plurality of second temperature sensor 140B may be contacted with the first conductive adhesive 130A. Also, all of the third thermal sensor 140C are contacted with any one of the second conductive adhesive 130B. However, not all of the third thermal sensor 140C may be contacted with any of the plurality of second conductive adhesive 130B. Only a third temperature sensor 140C of a portion of the third temperature sensor 140C may be contacted with the second conductive adhesive 130B.

The first temperature sensor 140A and the one or more second temperature sensor 140B are spaced apart in a third direction D3. The first temperature sensor 140A is farthest from the center C3 of the conductive member 120 in the third direction D3 among the first temperature sensor 140A and the one or more second temperature sensor 140B.

Between the battery module 110 and the cooling plate 122 (see FIG. 5), the first temperature sensor 140A and the one or more second temperature sensors 140B are located on the inner periphery of the flow path 122F formed in a substantially rectangular ring shape when viewed from the first direction D1.

The types of the first temperature sensor 140A, the second temperature sensor 140B, and the third temperature sensor 140C are not particularly limited, and may be any temperature detecting device capable of detecting a temperature such as a thermistor. Further, one or more circuit portions 150 are provided between the battery module 110 and the conductive member 120. The circuitry 150 may be, for example, a FPC (flexible printed circuit board). One or more circuit portions 150 are drawn from between the battery module 110 and the conductive member 120 and connected to one connector 160. The other control unit (not shown) and the temperature sensors are electrically connected to each other via the connector 160, so that the control unit can receive signals from the temperature sensors.

The stacked structure 100 further includes a first insulating plate 170 and a second insulating plate 180. The first insulating plate 170 is disposed between the first current collector plate 123 and the top surface portion 53. The first insulating plate 170 and the first current collector plate 123 are bonded to each other by a structural adhesive (not shown). The second insulating plate 180 is disposed between the second current collector plate 124 and the bottom surface portion 51. The second insulating plate 180 and the bottom surface portion 51 are bonded to each other by a structural adhesive (not shown). The second insulating plate 180 and the second current collector plate 124 are bonded to each other by a structural adhesive.

Here, a deformation condition of the power storage device 10 when the power storage device 10 including the stacked structure 100 according to the present embodiment is pushed up from one side (lower side) of the first direction D1 will be described.

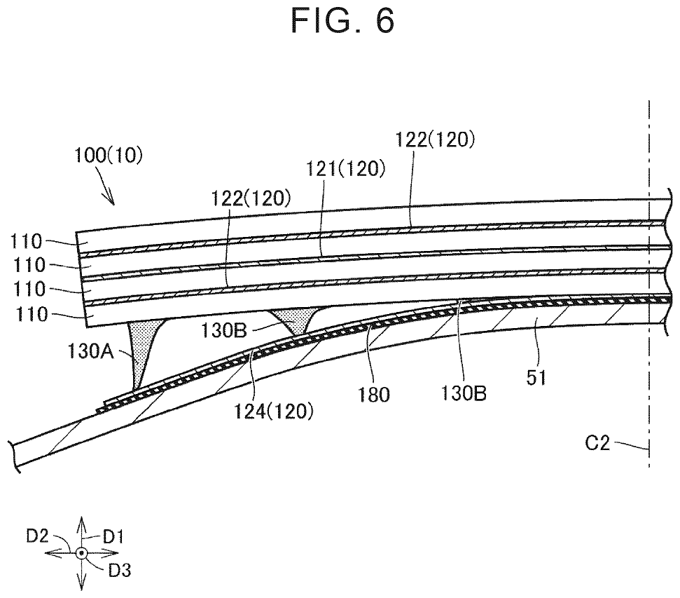

FIG. 6 is a partial cross-sectional view schematically showing a state in which the power storage device is deformed when the power storage device is pushed up from the lower side. As shown in FIG. 6, for example, when the power storage device 10 is mounted on the vehicle 1 (see FIG. 1), when the vibration is inputted to the power storage device 10 in the first direction D1 via the share panel 5, the power storage device 10 is pushed up from below. When the power storage device 10 is pushed up from below, the bottom surface portion 51 of the case 50 is curved upward in a convex shape. As the bottom surface portion 51 bends, the stacked structure 100 also bends upward in a convex shape. Thus, in the first direction D1, a force that causes the end portion of the battery module 110 and the end portion of the conductive member 120 to separate from each other acts on the stacked structure 100. When the end portion of the battery module 110 and the end portion of the conductive member 120 are separated from each other, the first conductive adhesive 130A may be partially peeled off from the battery module 110 or the conductive member 120.

Here, the first conductive adhesive 130A generates heat when electricity flows in the lamination direction of the stacked structure 100. When the first conductive adhesive 130A is partially peeled off from the battery module 110 or the conductive member 120 as described above, the interfacial resistivity between the first conductive adhesive 130A and the battery module 110 or the conductive member 120 increases. As a result, the first conductive adhesive 130A further generates heat, and the first conductive adhesive 130A is heated.

As described above, in the stacked structure 100 according to an embodiment of the present disclosure, the first temperature sensor 140A is disposed between the battery module 110 and the conductive member 120 so as to be contacted with the first conductive adhesive 130A. Thus, by detecting the temperature rise by the first temperature sensor 140A contacting the first conductive adhesive 130A, it is possible to accurately detect that the partial peeling occurs.

Further, in the stacked structure 100 according to an embodiment of the present disclosure, the first conductive adhesive 130A is farthest from the center C2 of the conductive member 120 in the second direction D2 among the first conductive adhesive 130A and the one or more second conductive adhesive 130B.

Since the first conductive adhesive 130A is positioned as described above, the first conductive adhesive 130A and the one or more second conductive adhesive 130B are relatively easily peeled off when the stacked structure 100 is bent (see FIG. 6). By detecting the temperature rise by the first temperature sensor 140A contacting the first conductive adhesive 130A, it is possible to accurately detect the occurrence of an anomaly in the adhesive between the battery module 110 and the conductive member 120.

Further, in the stacked structure 100 according to an embodiment of the present disclosure, the first temperature sensor 140A is farthest from the center C3 of the conductive member 120 in the third direction D3 among the first temperature sensor 140A and the one or more second temperature sensor 140B.

As described above, the first temperature sensor 140A is disposed in a portion of the first temperature sensor 140A and the one or more second temperature sensor 140B where partial peeling of the first conductive adhesive 130A is likely to occur, for example, when the stacked structure 100 is bent. By detecting the temperature rise by the first temperature sensor 140A, it is possible to detect the partial peeling of the first conductive adhesive 130A with higher accuracy.

Further, in the stacked structure 100 according to an embodiment of the present disclosure, the first direction D1, the second direction D2, and the third direction D3 are perpendicular to each other. Each of the first conductive adhesive 130A and the one or more second conductive adhesive 130B extends parallel to the third direction D3.

With the above configuration, the first conductive adhesive 130A and the one or more second conductive adhesive 130B are disposed between the battery module 110 and the conductive member 120 in a well-balanced manner. Therefore, the battery module 110 and the conductive member 120 are more firmly connected to each other while suppressing the use amount of the conductive adhesive.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A stacked structure comprising:
a battery module;
a conductive member stacked on the battery module;
a first conductive adhesive that is disposed between the battery module and the conductive member, bonds the battery module and the conductive member to each other, and electrically connects the battery module and the conductive member to each other; and
a first temperature sensor disposed between the battery module and the conductive member to be in contact with the first conductive adhesive.

2. The stacked structure according to claim 1, further comprising one or more second conductive adhesives, wherein
each of the one or more second conductive adhesives is disposed between the battery module and the conductive member, bonds the battery module and the conductive member to each other, and electrically connects the battery module and the conductive member to each other,
the first conductive adhesive and the one or more second conductive adhesives are arranged away from each other in a second direction intersecting a first direction in which the battery module and the conductive member are stacked, and
the first conductive adhesive is farthest from a center of the conductive member in the second direction among the first conductive adhesive and the one or more second conductive adhesives.

3. The stacked structure according to claim 1, further comprising one or more second temperature sensors, wherein
each of the one or more second temperature sensors is disposed between the battery module and the conductive member to be in contact with the first conductive adhesive,
the first temperature sensor and the one or more second temperature sensors are arranged away from each other in a third direction intersecting a first direction in which the battery module and the conductive member are stacked, and
the first temperature sensor is farthest from a center of the conductive member in the third direction among the first temperature sensor and the one or more second temperature sensors.

4. The stacked structure according to claim 2, further comprising one or more second temperature sensors, wherein
each of the one or more second temperature sensors is disposed between the battery module and the conductive member to be in contact with the first conductive adhesive,
the first temperature sensor and the one or more second temperature sensors are arranged away from each other in a third direction intersecting both the first direction and the second direction, and
the first temperature sensor is farthest from a center of the conductive member in the third direction among the first temperature sensor and the one or more second temperature sensors.

5. The stacked structure according to claim 4, wherein:
the first direction, the second direction, and the third direction are orthogonal to each other; and
the first conductive adhesive and the one or more second conductive adhesives extend parallel to the third direction.
